(19) United States
(12) Patent Application Publication
(10) Pub. No.: US 2025/0132141 A1
(43) Pub. Date: Apr. 24, 2025

(54) System and Method of Driving Radio Frequency for Multipole Ion Processing Device

(71) Applicant: DH Technologies Development Pte. Ltd., Singapore (SG)

(72) Inventors: Takashi BABA, Richmond Hill (CA); Manuel FAUR, Toronto (CA); Tiberiu GERA, Etobicoke (CA); Robert HAUFLER, Toronto (CA); William LOYD, Sugar Land, TX (US); Pavel RYUMIN, Toronto (CA); Congsheng YOU, Concord (CA)

(21) Appl. No.: 18/685,537

(22) PCT Filed: Aug. 23, 2022
(86) PCT No.: PCT/IB2022/057908

§ 371 Date: Feb. 22, 2024

Related U.S. Application Data
(60) Provisional application No. 63/284,427, filed on Nov. 30, 2021.
(60) Provisional application No. 63/236,997, filed on Aug. 25, 2021.

(51) Int. Cl. H01J 49/02; H01J 49/00; H01J 49/42

(52) U.S. Cl. CPC H01J 49/022; H01J 49/0045; H01J 49/424

(57) ABSTRACT

A system for applying RF voltages to a multipole ion processing device, configured for use in a mass spectrometer, includes a first RF generator configured to generate a first RF voltage and apply to a first pole electrode set, a second RF generator configured to generate a second RF voltage and apply to a second pole electrode set, a first amplitude adjustor configured to adjust an amplitude of the first RF voltage, a second amplitude adjustor configure to adjust an amplitude of the second RF voltage, and a phase adjustor in communication with the first RF generator and the second RF generator to adjust phase output of at least one of the first RF generator and the second RF generator so as to adjust a phase differential between the first RF voltage and the second RF voltage to be within a desired range.

### RELATED APPLICATIONS

This application claims priority to U.S. provisional application No. 63/236,997 filed on Aug. 25, 2021, entitled “System and Method of Driving Radio Frequency for Multipole Ion Processing Device,” which is incorporated herein by reference in its entirety and to U.S. provisional application No. 63/284,427 filed on Nov. 30, 2021, entitled “System and Method of Driving Radio Frequency for Multipole Ion Processing Device,” which is incorporated herein by reference in its entirety.

### TECHNICAL FIELD

The present disclosure relates to systems and methods of driving a radio frequency (RF) circuit for an electron-activated dissociation (EAD) device used in a mass spectrometer, and more particularly, to such systems and methods that can be employed for applying RF voltages to a multipole EAD device with independent tank coils, where the amplitudes and/or the phases of the generating RF voltages can be controlled separately so as to optimize one or more performance metrics of the EAD device.

### BACKGROUND

Ion reactions typically involve the reaction of either a positively or negatively charged ion with another charged species, which can be another positively or negatively charged ion or an electron. In electron-activated dissociation (EAD), for example, the charged species is an electron beam, and the electron impingement on an ion results in the fragmentation of the ion. EAD has been used to dissociate bio-molecules in mass spectrometry (MS), and has provided capabilities that cover a wide range of possible applications from regular proteomics in liquid chromatography-mass spectrometry/mass spectrometry (LC-MS/MS) to top down analysis (no digestion), de novo sequencing (abnormal amino acid sequence finding), post translational modification study (glycosylation, phosphorylation, etc.), protein-protein interaction (functional study of proteins), and also including small molecule identification.

The mechanisms for EAD can include, for example, electron capture dissociation (ECD) using electrons having kinetic energies of 0 to 3 eV, Hot ECD (electrons with kinetic energy of about 5 to about 15 eV), and electron ionization dissociation (EID) (electrons with kinetic energy greater than about 13 eV). These electron activated dissociations are considered to be complementary to conventional collision induced or activated dissociations (CID or CAD) and have been incorporated in advanced MS devices.

The usage of the term EAD in the present teachings hereinafter should be understood to encompass all forms of free electron-related dissociation techniques, and is not limited to the usage of electrons within any specific degree of kinetic energy.

In an EAD device, a precise control of electron energy is desirable for at least the following reasons. First, such control of the electron energy can help maximize EAD efficiency if electron-ion interaction cross-section exhibits a significant dependence on the electron energy (narrow electron capture energy range). Second, in order to study fragmentation pathways, it is beneficial to have a device with precise energy control. Third, certain diagnostic ions can yield structural information if measured quantitatively in a specific energy regime, and hence having well controlled electron energy can be important in such application.

Conventionally, EAD devices are implemented in ion cyclotron resonance (ICR) cells, where the ions are confined radially by strong magnetic field and axially by DC electrical fields with the electrons emitted by a heated cathode. In such devices, there are no time-variant fields in the ICR cell during reaction, which results in electron energy spread being largely defined by the thermal spread of the emitted electrons.

Recently, it was shown that efficient EAD device could be realized in various ion traps employing strong RF fields for ion confinement. For example, there are EAD devices based on a linear ion trap described in the literature (Baba et al. “Electron Capture Dissociation in a Radio Frequency Ion Trap,” 2004, Analytical Chemistry, 76 (15), 4263-4266) and based on a branched RF ion trap (Baba et al. “Electron Capture Dissociation in a Branched Radio-Frequency Ion Trap,” 2015, Analytical Chemistry, 87 (1), 785-792). Such devices have some advantages over conventional EAD enabled ICR instruments. First, there is no need for expensive superconductive magnets. Second, the EAD reaction is more efficient because trapped ions are cooled by gas collisions in a strong confinement potential so that the ions have a better overlap with the electron beam.

### SUMMARY

In view of the development of the EAD devices employing RF ion traps, there is a need for an improved method of operating such EAD devices with better control of RF fields without significant perturbation of electron motion. RF ion processing devices typically include a multipole electrode sets, where the number of electrodes is often even. A linear quadrupole, which is the most common configuration, includes parallel four rod electrodes placed at the same distance from the center axis with the 90-degree symmetry. Two radio frequency voltages with 0 and 180 degree phases with the same frequency and a similar amplitude are applied to the two pairs of the rod electrodes. The first rod electrode pair is the two rods located opposite relative to the central axis, and the second rod electrode pair is another set of two rod electrodes located at 90 degrees from the first rod electrode pair. The teachings of the present disclosure are not limited to the linear quadrupole, but also linear multipoles, such as hexapole, octapole, decapole, dodecapole, and higher-order multipoles. In these higher-order multipoles, two RF voltages with 180-degree phase difference is still applied to the rod electrode pairs. The rod electrode set that is applied with the RF voltage with the 0-degree phase is often referred to as the first pole electrode set, and the rod electrode set that is applied with the RF voltage with about 180-degree phase relative to the first RF voltage is often referred to as the second pole electrode set. In some embodiments, this definition is expanded to the branched configuration using L-shaped electrodes instead of the linear rod electrodes.

An aspect of the present teachings provides a system for applying RF voltages to an ion processing device having at least two rod electrodes, typically more than four rod electrodes, the ion processing device being configured for use in a mass spectrometer. The system comprises a first RF generator configured to generate a first RF voltage and apply to a first pole electrode set, a second RF generator configured to generate a second RF voltage and apply to a second pole electrode set, a first amplitude adjustor configured to adjust an amplitude of the first RF voltage, and a second amplitude adjustor configure to adjust an amplitude of the second RF voltage. In some embodiments, the system further comprises a relative phase adjustor in communication with the first RF generator and the second RF generator to adjust phase output of at least one of the first and second RF generators so as to adjust a phase differential between the first RF voltage and the second RF voltage to be within a desired range. In some such embodiments, the first RF voltage has a fixed phase output, and the second RF voltage has a variable phase output, such that the variable phase output of the second RF voltage can be adjusted by the phase adjustor.

The ion processing device can comprise any of multipole RF devices, including an ion guide, an ion trap, an ion-ion reaction device, ion-electron reaction device, ion-neutral reaction device, an ion mass filter, and the like.

In some embodiments, the system further comprises a phase discriminator for determining the phase differential between the first RF voltage and the second RF voltage and generating a signal indicative of the phase differential, and a feedback circuitry for receiving the signal and adjusting the phase of the second RF voltage so as to maintain the phase differential to a predetermined value. By way of example, the predetermined value can be about −180 degrees. In some embodiments, the feedback circuitry is implemented in a proportional-integral-derivative (PID) controller. In some embodiments, the phase discriminator is in communication with the first pole electrode set and the second pole electrode set, thereby measuring the phase differential therebetween.

In some embodiments, each of the first amplitude adjustor and the second amplitude adjustor comprises a detector configured to generate a signal indicative of an amplitude of respective RF voltages, and a feedback circuitry for receiving the signal and generating a feedback signal for application to respective RF generators. The feedback circuitry can be implemented in a proportional-integral-derivative (PID) controller. The feedback circuitry can be configured to balance the amplitude of respective RF voltages so as to optimize one or more performance metrics of the ion processing device.

In some embodiments, the first RF voltage and the second RF voltage have a same frequency. In some embodiments, the first RF voltage and the second RF voltage are sinusoidal. In some other embodiments, the first RF voltage and the second RF voltage are non-sinusoidal.

In some embodiments, the system further comprises at least one RF amplifier positioned between at least one of the RF generators and pole electrode sets of the ion processing device associated with the at least one RF generator. The at least one RF amplifier can comprise a resonant tank coil. The at least one RF amplifier can further comprise a resonant transformer.

In some embodiments, the phase adjustor is configured for a mapping between input phase delay and one or more performance metrics, and controls the input phase delay based on the mapping by monitoring the performance metrics.

In some embodiments, the system further comprises an additional RF amplifier between an input signal and output signal, the additional RF amplifier comprising a resonant tank coil.

In some embodiments, the first RF generator, the second RF generator, or both are implemented as a digital circuitry.

In some embodiments, the system drives an RF ion trap configured to simultaneously trap ions and introduce electrons for ion-electron reaction. In some such embodiments, electrons are configured to enter the RF ion trap along an axis with minimal RF field-induced distortion. In some such embodiments, relative balance of amplitudes of the first and second RF voltages is adjusted to minimize the RF field-induced distortion along the axis of electron introduction. In some such embodiments, the phase differential between the first and second RF voltages is adjusted to minimize the RF field-induced distortion along the axis of electron introduction. In some embodiments, the system further comprises a magnetic field circuit configured to confine the electrons to the axis with minimal RF field-induced distortion.

In some embodiments, the RF ion trap is capable of introducing ions and collecting products, and at least one port is provided for introducing electrons. By way of example, the RF ion trap can be implemented in a branched configuration.

In some such embodiments, the RF ion trap with the branched configuration comprises a plurality of L-shaped rods arranged relative to one another to provide an axial passageway having an inlet for receiving a plurality of ions and an outlet through which ions are allowed to leave the axial passageway, and a transverse passageway having at least one inlet for receiving electrons generated by an electron source. In some such embodiments, the axial and transverse passageways intersect at an electron-ion interaction region in which at least a portion of the received electrons interact with at least a portion of the received ions. In some such embodiments, the RF ion trap is configured to ensure that electrons remain substantially close to a central axis of the transverse passageway while propagating along the transverse passageway. In some embodiments, the plurality of L-shaped rods form an ion guide providing a passageway for transmission of ions therethrough.

Another aspect of the present teachings provides a method of operating an ion processing device having at least two sets of pole electrodes. The method comprises applying a first RF voltage to a first pole electrode set of the ion processing device, applying a second RF voltage to a second pole electrode set of the ion processing device, and balancing at least one of an amplitude of the first RF voltage and an amplitude of the second RF voltage to optimize one or more performance metrics.

In some embodiments, the method of operating an ion processing device having at least two pole electrode sets comprises applying a first RF voltage to a first pole electrode set of the ion processing device, the first RF voltage being generated by a first RF generator, applying a second RF voltage to a second pole electrode set of the ion processing device, the second RF voltage being generated by a second RF generator, and adjusting at least one of an amplitude of the first RF voltage using a first amplitude adjustor and an amplitude of the second RF voltage using a second amplitude adjustor.

In some embodiments, the method further comprises adjusting phase output of at least one of the first RF generator and the second RF generator using a phase adjustor in communication with the first RF generator and the second RF generator so as to adjust a phase differential between the first RF voltage and the second RF voltage to be within a desired range. In some embodiments, the first RF voltage has a fixed phase output, and the second RF voltage has a variable phase output, such that the variable phase output of the second RF voltage can be adjusted by the phase adjustor.

In a related aspect of the present teachings provides a system for applying RF voltages to an ion processing device having at least two pole electrode sets, configured for use in a mass spectrometer. The system comprises at least one RF generator configured to generate a first RF voltage and a second RF voltage for application to a first pole electrode set and a second pole electrode set of the at least two pole electrode sets, respectively, and at least one balancing variable capacitor electrically coupled with the first pole electrode set or the second pole electrode set. In some embodiments, at least one electromechanical actuator is operably coupled to the variable capacitor for adjusting capacitance thereof for balancing amplitudes of the first RF voltage and the second RF voltage to be within a desired range.

In some embodiments, the electromechanical actuator comprises at least one of a servo motor, a step motor, a linear motor, a hydraulic actuator, or a pneumatic actuator.

In some embodiments, the system further comprises a tuning variable capacitor electrically coupled between the first pole electrode set and the second pole electrode set so as to adjust impedance of the system.

In some embodiments, the system comprises a detector configured to generate a signal indicative of an amplitude of respective RF voltages, and a feedback circuitry for receiving the signal and generating a feedback signal for application to the electromechanical actuator. In some such embodiments, the feedback circuitry is configured to balance the amplitude of respective RF voltages so as to optimize one or more performance metrics of the ion processing device. The feedback circuitry can comprise a proportional-integral-derivative (PID) controller.

In some embodiments, the system further comprises at least one RF amplifier operably coupled between the RF generator and at least one of the pole electrode sets of the ion processing device for amplifying the RF voltage applied to that pole electrode set. In some such embodiments, the at least one RF amplifier is configured as a high-efficiency gain circuit.

In some embodiments, the feedback circuitry is configured for a mapping between input signals to the electromechanical actuator and one or more performance metrics of the ion processing device, and configured to control the electromechanical actuator based on the mapping by monitoring the one or more performance metrics. By way of example, the one or more performance metrics comprise at least one of an electron current emitted by a filament, an electron capture efficiency, a width of an electron capture profile, a shift in an apex of a mass signal, and an intensity of a mass peak in a mass spectrum.

In some embodiments, the system further comprises an additional RF amplifier between an input signal and an output signal, and the additional RF amplifier can be configured as a high-efficiency gain circuit.

In some embodiments, the RF generator is configured as a digital circuitry.

In some embodiments, the first RF voltage and the second RF voltage have a same frequency. In some embodiments, the first RF voltage and the second RF voltage are sinusoidal. In some other embodiments, the first RF voltage and the second RF voltage are non-sinusoidal.

In some embodiments, the ion processing device comprises any of an ion guide, an ion device with multiple poles, an ion trap, an ion-reaction device, or an ion mass filter.

In some embodiments, the system drives an RF ion trap configured to simultaneously trap ions and introduce electrons for ion-electron reaction. In some such embodiments, electrons are configured to enter the RF ion trap along an axis with minimal RF field-induced distortion. Further, relative balance of amplitudes of the first and second RF voltages is adjusted to minimize the RF field-induced distortion along the axis of electron introduction. In some embodiments, the amplitudes of the first and second RF voltages are adjusted to minimize the RF field-induced distortion along the axis of electron introduction. In some embodiments, the system further comprises a magnetic field circuit configured to confine the electrons to the axis with minimal RF field-induced distortion. In some embodiments, the RF ion trap is capable of introducing ions and collecting products, and at least one port is provided for introducing electrons.

In some embodiments, the RF ion trap is implemented in a branched configuration. In some such embodiments, the RF ion trap with the branched configuration comprises a plurality of L-shaped rods arranged relative to one another to provide an axial passageway having an inlet for receiving a plurality of ions and an outlet through which ions are allowed to leave the axial passageway, and a transverse passageway having at least one inlet for receiving electrons generated by an electron source. In some such embodiments, the axial and transverse passageways intersect at an electron-ion interaction region in which at least a portion of the received electrons interact with at least a portion of the received ions. In some such embodiments, the RF ion trap is configured to ensure that electrons remain substantially close to a central axis of the transverse passageway while propagating along the transverse passageway. In some embodiments, the plurality of L-shaped rods form an ion guide providing a passageway for transmission of ions therethrough.

In another related aspect of the present teachings, a method of operating an ion-electron reaction device having at least two pole electrode sets is provided. The method comprises applying a first RF voltage to a first pole electrode set of the ion-electron reaction device, applying a second RF voltage to a second pole electrode set of the ion-electron reaction device, and adjusting capacitance of at least one variable capacitors electrically coupled to the first or second pole electrode set so as to balance amplitudes of the first RF voltage and the second RF voltage to be within a desired range.

In some embodiments, the adjusting capacitance comprises adjusting the variable capacitors using at least one electromechanical actuator. By way of example, the electromechanical actuator comprises at least one of a servo motor, a step motor, a linear motor, a hydraulic actuator, or a pneumatic actuator. In some embodiments, the adjusting capacitance comprises manually operating the electromechanical actuator. In some other embodiments, the adjusting capacitance comprises feedback-controlling the electromechanical actuator based on measured amplitudes of the first RF voltage and the second RF voltage. In some embodiments, the adjusting capacitance comprises feedback-controlling the electromechanical actuator based on one or more performance metrics of the ion-reaction device. By way of example, the one or more performance metrics comprise at least one of an electron current emitted by a filament, an electron capture efficiency, a width of an electron capture profile, a shift in an apex of a mass signal, and an intensity of a mass peak in a mass spectrum.

### BRIEF DESCRIPTION OF THE DRAWINGS

FIG. 1A shows a top view of an example of EAD devices using a branched RF ion trap;

FIG. 1B shows a cross-sectional top view of an example of EAD devices using a branched RF ion trap;

FIG. 1C shows a side view of an example of EAD devices using a branched RF ion trap;

FIG. 1D shows a perspective view of an example of EAD devices using a branched RF ion trap;

FIG. 2 shows electron capture efficiency with respect to balancing of RF A and RF B;

FIG. 3 shows electron capture efficiency with respect to phase difference of RF A and RF B voltages;

FIG. 4 shows electron current with respect to electron kinetic energy for different RF phase settings (best value at HF1=1);

FIG. 5 shows electron current with respect to electron kinetic energy for different RF balancing settings (best value at HS1=0);

FIG. 6 compares data for electron capture efficiency for 2⁺ ammoniated Triacetyl-β-cyclodextrin ion using filament 1 under different RF balancing conditions;

FIG. 7 compares data for electron capture efficiency for 2⁺ ammoniated Triacetyl-β-cyclodextrin ion using filament 1 under different RF phase shift conditions;

FIG. 8 shows an example of an EAD RF drive circuit with independent tank coils and circuitry for controlling phases of RF A and B;

FIG. 9 shows an example of an EAD RF drive circuit with balancing capacitors;

FIG. 10 schematically shows an example of a variable capacitor with an electromechanical actuator that is controlled via a feedback circuitry;

FIG. 11 shows electron capture efficiency for 2⁺ ammoniated Triacetyl-β-cyclodextrin ion using filament 1; and

FIG. 12 shows electron capture efficiency for 2⁺ ammoniated Triacetyl-β-cyclodextrin ion using filament 2.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed an any great detail. One of ordinary skill will recognize that some embodiments of the present disclosure may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

Various terms are used herein in accordance with their ordinary meanings in the art. For example, the term “mass ion filter” and “ion filter” are used herein interchangeably to refer to a structure that can be employed, for example, in a mass spectrometer, for limiting the transmission of ions to those having a target m/z ratio or an m/z ratio within a target range. The terms “mechanical misalignment” and “misalignment” are used herein interchangeably to refer to deviation of one or more components of an ion mass filter relative to its nominal position (i.e., relative to the intended position). Such a misalignment can occur along a longitudinal direction of the ion mass filter and/or along a radial direction (i.e., a direction perpendicular to the longitudinal direction) of the mass filter.

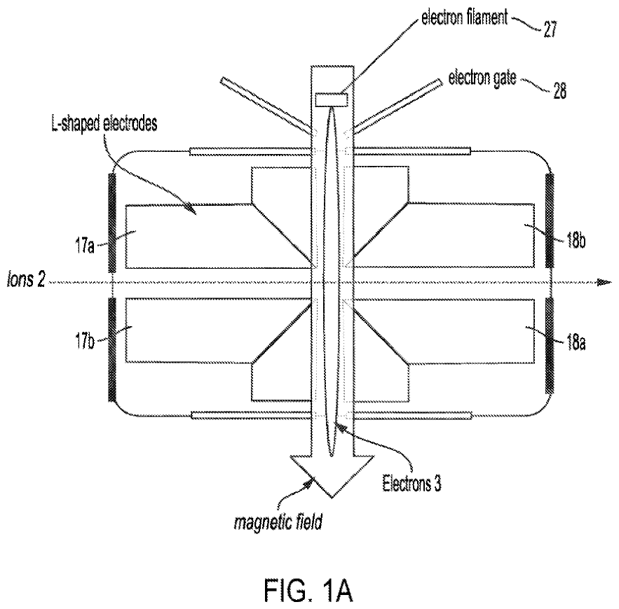

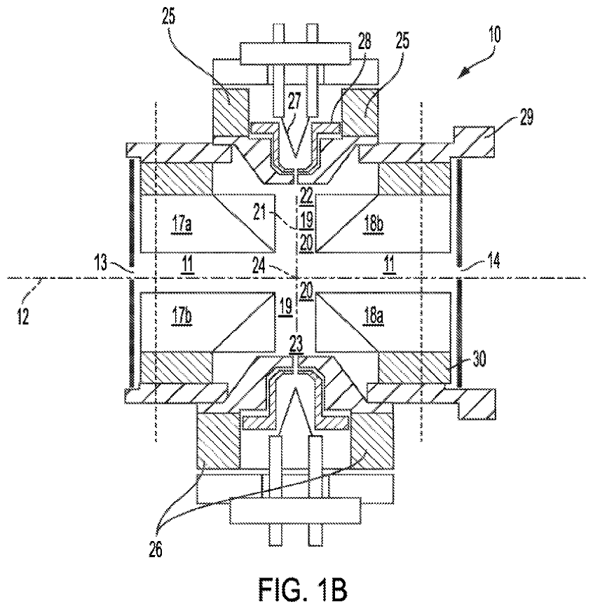

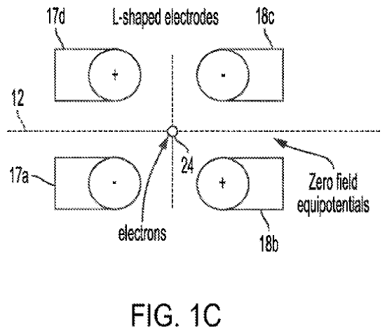

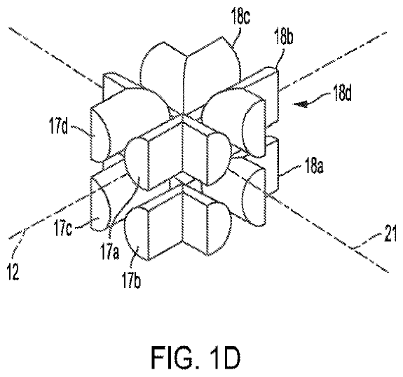

FIGS. 1A-1D illustrate an example of an ion processing device 10 in which an RF driving system according to an embodiment of the present teachings can be incorporated. Referring to FIG. 1B, shown as a cut-out cross section, an outer cylindrical housing 29 and an inner cylindrical housing 30 surround a first pathway 11 having a first central axis 12 and a first axial end 13 and a second axial end 14. This pathway provides a path for ions 2 to enter into the ion processing device 10 (see FIG. 1A).

The ion processing device 10 comprises a first set of quadrupole electrodes 17 (two of which 17a and 17b are visible in FIGS. 1A and 1B) that are mounted to the inner cylindrical housing 30, the electrodes 17 being arranged around the first central axis 12 in a quadrupole type arrangement. While quadrupoles are specifically embodied here for ease of discussion of the operation of the ion processing device, any arrangements of multipoles could also be utilized, including hexapoles, octupoles, etc. As noted above, in FIG. 1B, only two of the four quadrupole electrodes 17, namely, rods 17a and 17b, are depicted. However, as shown in FIG. 1D, the other two electrodes 17c and 17d are directly behind the depicted electrodes. The quadrupole rods 17 can be operably connected to an RF voltage generator, which applied RF voltages to those rods for generating an electromagnetic field within the quadrupole for radially confining the ions passing through the quadrupole. The polarity of the RF voltage applied to one pair of the quadrupole rods is opposite to the polarity of the RF voltage to another pair of the quadrupole rods. More specifically, one pair of radially opposed quadrupole rods 17a and 17c forms one electrode set of the quadrupole rod and the other pair of radially opposed quadrupole rods 17b and 17d forms another pole electrode set of the quadruple rods. The polarity of the RF voltages applied to one pole electrode set is opposite to the polarity of the RF voltage applied to the other pole electrode set while the amplitudes of the RF voltages applied to the two pole electrode sets are the same.

A second set of quadrupole electrodes 18 (two of which 18a and 18b are visible in FIGS. 1A and 1B) are also mounted to the inner cylindrical housing 30 and is situated at a slight distance away from the first set of quadrupole electrodes 17 along the first central axis 12, the distance forming a mostly cylindrical shaped gap 19 between the first set 17 and second set 18 of electrodes. Similar to the first set of quadrupole electrodes 17, in FIG. 1B, only two of the four quadrupole electrodes 18, namely, rods 18a and 18b, are depicted. However, as shown in FIG. 1D, the other two electrodes 18c and 18d are directly behind the depicted electrodes 18a and 18b.

The first set 17 and second set 18 quadrupole electrodes share the same central axis 12 and the rods of the first set of quadrupoles 17 are in line with the second set of quadrupoles 18. While being depicted as a cylindrical shape, it should be appreciated that the shape of this gap is not limited thereto, but rather that there exists a gap between the first 17 and second 18 set of quadrupoles. For example, this shape could also be described as being a rectangular box shape, even though the quadrupoles have the same configuration. This second set of quadrupole electrodes 18 is also connected to an RF voltage generator, which serves to provide RF voltages to the electrodes to generate an RF field which can serve to guide ions, and/or product ions towards the central axis 12, the midpoint of the second set 18 of quadrupole electrodes.

Further, the inner and outer cylindrical housings have a cut-out for insertion of a second pathway 20, having a second central axis 21 which has a first axial end 22 and second axial end 23. This second pathway 20 provides a path for the transport of electrons 3 into the ion processing device 10 (see FIG. 1A). The first and second pathways are substantially orthogonal to one another and meet at an intersection point 24, which is along the first 12 and second 21 central axis. Due to the L-shape, the first set 17 and second set 18 quadrupole electrodes can provide the first pathway 11 and the second pathway 20 along the first central axis 12 and the second central axis 21, respectively, as shown in FIG. 1D.

The first axial end 22 of the second pathway 20 contains or has proximate to it, an electron filament 27 that is used to generate electrons 3 for transmission into the second pathway 20 towards the intersection point 24. The first axial end 22 can also contain or have proximate to it, one or more suitable electrode gates 28 to control the entrance of electrons 3 into the ion processing device 10. A magnetic field source, such as magnets 25 and 26, is configured to implement a magnetic field that is parallel to the second pathway 20 as shown in FIG. 1B. In some embodiments of the ion processing device 10, more than one (e.g., two) electron filament 27 can be included, for example to extend unperturbed operation even when the other filament has degraded.

In certain embodiments, the RF frequencies applied to the quadrupoles are in the range of about 100 kHz to about 10 MHz, or in the range of about 400 kHz to about 1.2 MHZ, or preferably the RF frequency is around 800 kHz.

The devices that confine the ions by a magnetic field present several disadvantages. For example, the most convenient mass analyzer for setting up EAD based on ICR cells require a very stable magnetic field for their proper operation, which is typically implemented using superconductive magnets. The need for superconductive magnets, however, increases the device cost and complexity.

In general, the success of the overall scheme for electron energy control is generally dependent on how well the zero field condition along the electron axis is satisfied. Multiple parameters affect the zero field condition. First, the accuracy of the electron emitter alignment with respect to the EAD cell can influence the zero field condition. Second, the precision to which the opposite RF A and RF B voltages are matched can also affect the zero field condition. Both the electron emitter misalignment and asymmetrical (unbalanced) RF field can contribute to the electron energy distortion along the axis field, which varies with time. To some extent, those effects can compensate each other.

Some circuits used for driving multipole ion guides/ion traps usually utilize a common tank coil (Jones et al. “Simple radio-frequency power source for ion guides and ion traps,” 1997, Review of Scientific Instruments, 68, 3357). In such circuits, the RF amplitudes can be balanced for optimal performance. However, such a scheme is inconvenient for a few reasons. First, if a device is equipped with more than one filament (for example to extend unperturbed operation of the instrument, when the other filament has degraded) the optimal balancing point may differ for those filaments due to the imperfect mechanical alignment between the two filaments.

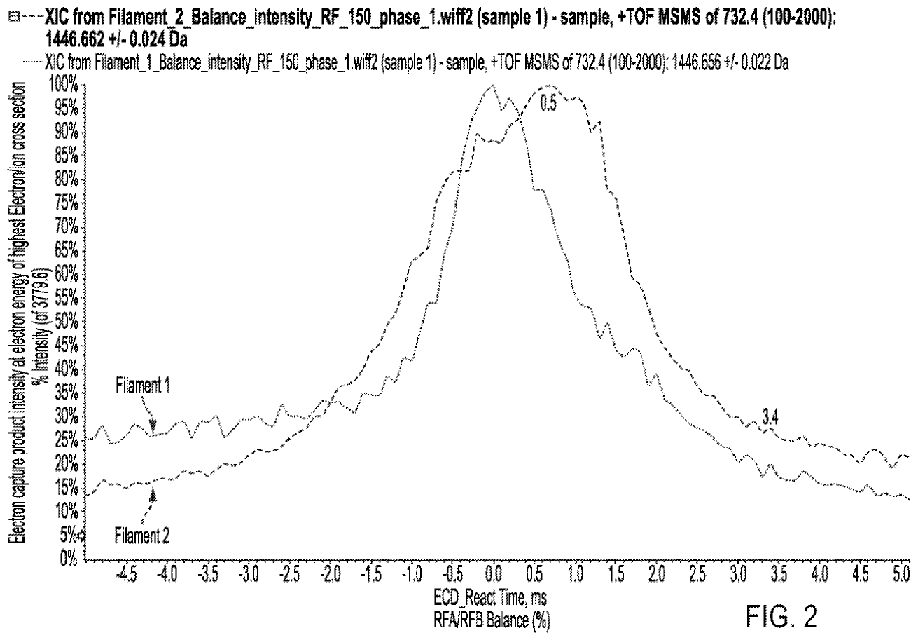

FIG. 2 shows the performance for different balancing conditions recorded for two filaments installed on a branched RF ion trap, where apex corresponds to the maximum electron capture, which is the optimal balancing point. In this example, the reaction [Triacetyl-β-cyclodextrin+2 NH4]²⁺+e⁻→[Triacetyl-β-cyclodextrin+NH4]⁺ is monitored. As shown in FIG. 2, for the branched RF ion trap, optimal balancing point can differ for the two filaments in the same EAD device.

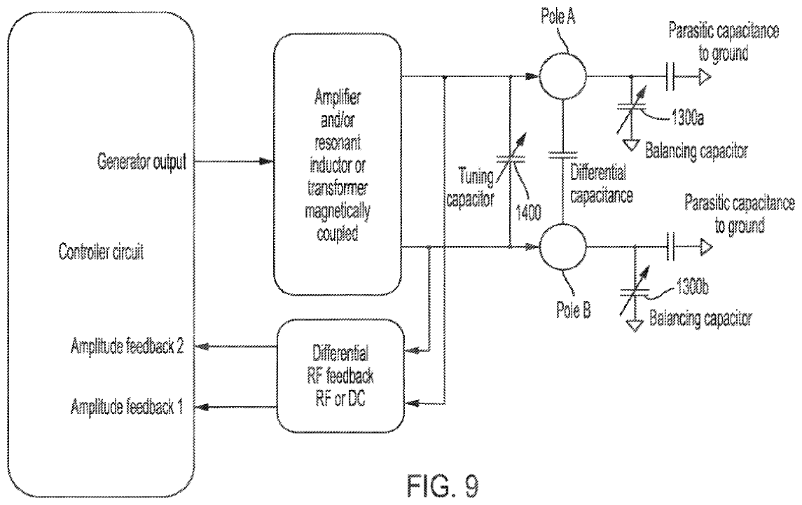

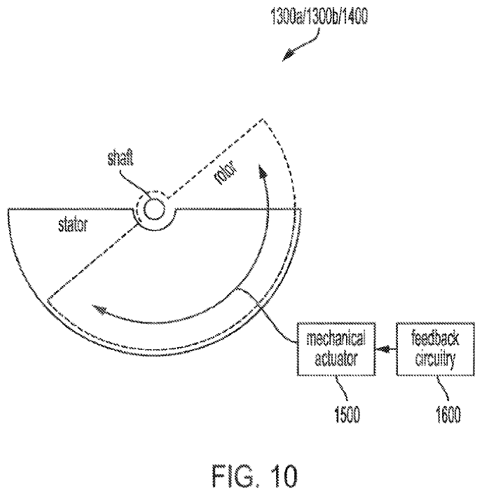

In the circuits used for driving multipole ion processing devices (e.g., ion guides or ion traps) according to some embodiments of the present teachings, a common tank coil can be used. An advantage of such a circuit with a common tank coil is that the opposite RF phases are phase-locked at −180 degrees. In such embodiments with a common tank coil, when a device is equipped with more than one filament, the optimal balancing point may differ for those filaments due to misalignment of the filaments. Accordingly, in some embodiment, for fine-tuning and balancing, a set of adjustable capacitors can be employed. Such embodiments will be discussed in more detail later below with reference to FIGS. 9 and 10.

An aspect of the present teachings provides a system including a plurality of radio frequency (RF) generators for driving, for example, two pole electrode sets of an ion processing device employed in a mass spectrometer. In some embodiments, the RF generators can include independent inductive elements (herein also referred to as tank coils) and the system can include circuitry for providing independent control (e.g., digital control) of the phases of the RF signals generated by the RF generators. Without any loss of generality and only for the ease of description, in the following discussion, it is assumed that a system according to the present teachings includes two RF generators, where in some cases one of the RF generators is referred to as RF A and the other as RF B.

As discussed in more detail below, in embodiments, a system according to the present teachings can provide adjustable balancing points for each individual filament. In particular, to ensure that the phase differential between the RF A and the RF B is maintained at about −180 degrees, even with independent tank coils, the phase differential can be monitored and controlled via a feedback circuitry.

In general, the phase difference between the RF A and the RF B signals can vary depending on the capacitance of each individual RF generating circuit, and in certain cases, applied RF voltage. RF phase shift can also generate an on-axis electric field, making performance of an EAD device with such circuit unsatisfactory.

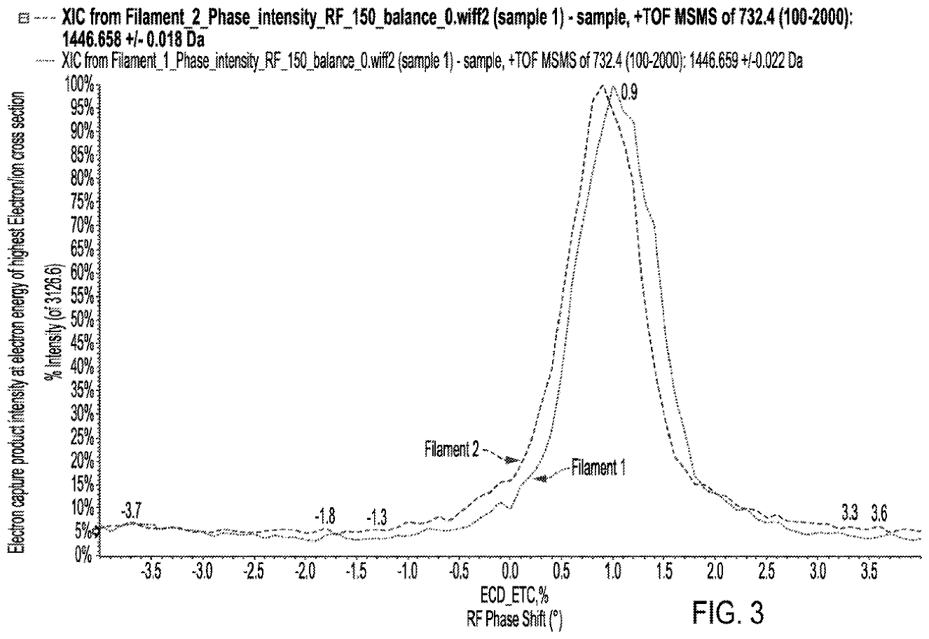

By way of illustration, FIG. 3 shows electron capture efficiency in an EAD device as a function of the phase difference between the RF A and RF B voltages. The horizontal axis represents the RF phase shift with respect to 180°, and FIG. 3 illustrates how a relative phase shift compared to an optimal value of 1.0 offset from 180° leads to a quick degradation in electron capture efficiency in the following reaction: [Triacetyl-β-cyclodextrin+2 NH4]²⁺+e⁻→[Triacetyl-β-cyclodextrin+NH4]⁺. In this experiment, the electron energy was tuned to the resonant capture value and the performance of the setup was monitored depending on the relative phase difference of the circuit. Low electron capture efficiency indicates that only a small fraction of electrons reacting with the ion of interest have resonant electron energy, while the remaining electrons have differing energy. Conversely, high electron capture efficiency indicates that a substantial fraction of the electrons has resonant electron energy. Overall, FIG. 3 illustrates that the phase of applied RF voltages is important for providing good electron energy control.

According to embodiments of the present teachings, to address this problem, RF A and RF B phases as well as RF A and RF B amplitudes can be controlled, via a digital feedback circuitry, to ensure that the phase differential and/or the amplitude differential between the RF A and RF B signals remains within a predefined range or at a predefined value. In some embodiments, one or more performance metrics can be used to find optimal balancing between the phases and/or amplitudes of the RF A and RF B signals and ensure that the performance metric(s) would remain within a target range. In some embodiments, the amplitude of any of the RF A and RF B signals relative to the electric ground can be adjusted.

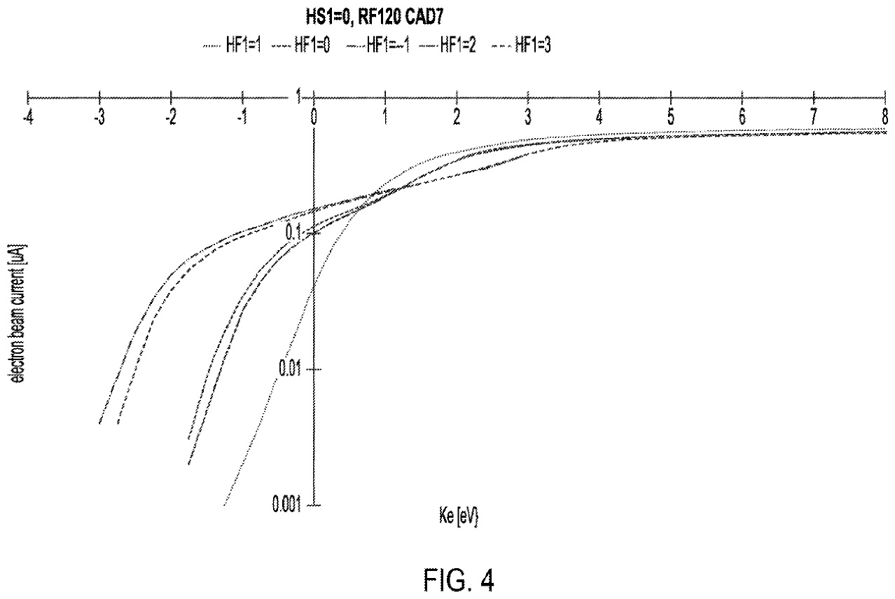

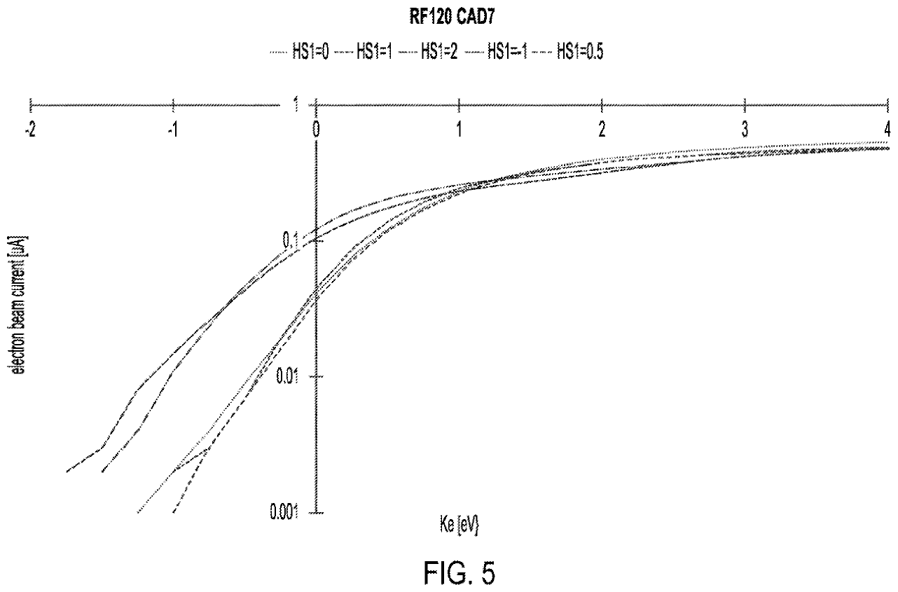

One example of such performance metric(s) used in an EAD device such as that described above in connection with FIGS. 1A-1D can be, without limitation, an electron current emitted by a filament under <0 eV average kinetic energy condition. FIGS. 4 and 5 show the emitted electron current at different electron energy for different RF phase and RF balancing settings, respectively. Here, the energy is defined based on the relative filament bias between the emitter and the pole electrode sets. As the filament is biased positively (i.e., negative kinetic energy in the plot) relative to the pole electrode sets, the electrons emitted from the filament are prevented from traveling toward the EAD cell and instead are recaptured by either the filament or adjacent lenses with more positive potential. In FIGS. 4 and 5, the RF balancing refers to the relative voltage amplitudes applied to two pole electrode sets of the quadrupole rod sets, or more generally to two pole electrode sets of an ion processing device. By way of example, a circuit may be said to be unbalanced where RF A pole-to-ground voltage is 210 V and RF B pole-to-ground is 200 V. On the other hand, a circuit may be said to be balanced where the RF pole-to-ground voltages of RF A and RF B are both 205V.

High emitted current at set electron energies of <0 eV suggests that the electrons have enough energy to overcome the barrier and hence there is a significant discrepancy between set negative energy and actual electron energy originating from RF excitation of the electrons. Low emitted current at electron energies <0 eV suggests that there is no significant excitation of the emitted electrons by RF field, and such a condition can be considered optimal. Another example of a performance metric that can be monitored is the efficiency of electron capture in a test ion electron reaction.

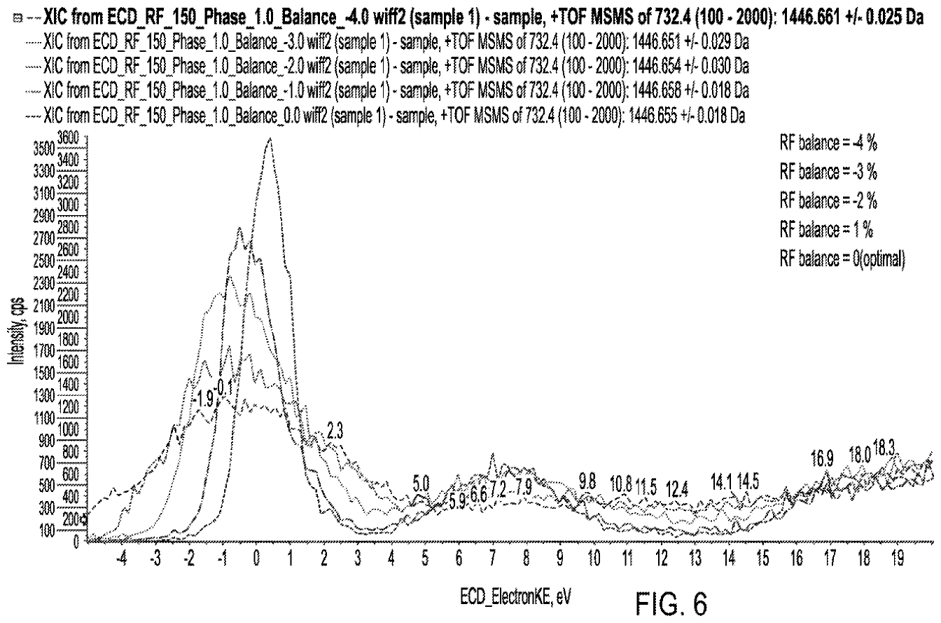

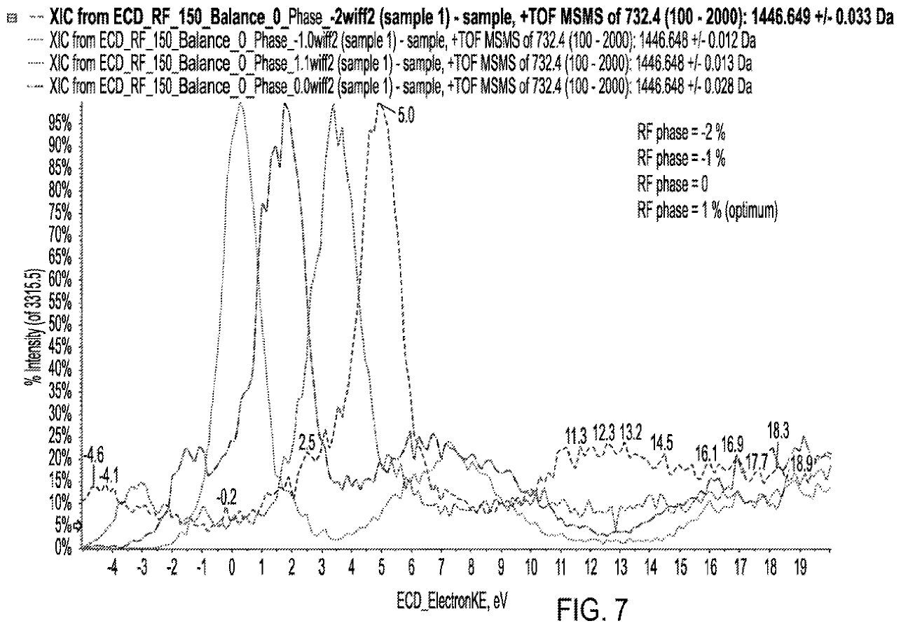

FIGS. 6 and 7 show such dependency for different balancing and phase conditions of RF A and RF B signals, respectively for monitoring the product of the [Triacetyl-β-cyclodextrin+2 NH4]²⁺+e⁻→[Triacetyl-β-cyclodextrin+NH4]⁺ reaction. Another possible metric can be the width of the electron capture profiles at low electron kinetic energy (Ke) (measured using the same reaction). FIG. 6 shows mass signals associated with an ion generated by electron capture dissociation of [Triacetyl-β-cyclodextrin+2 NH4]²⁺ for each RF balancing point, as a function of electron energy. As shown in FIG. 6, when the balancing point is shifted from the optimal position (i.e., 0), the mass signal is widened, which indicates that the electron capture profile is widened, thereby yielding substantially worse total electron capture at the optimal electron energy. This is because the optimal electron energy setting in unbalanced case contains many electrons of different energies.

In contrast to or in addition to the width of a mass signal for different RF balances, in some embodiments, a shift in the apex of a mass signal can be used as a metric and can be monitored to adjust the phase and/or the amplitude of the RF A and RF B signals. By way of illustration, FIG. 7 shows a shift in the apex of the electron capture profile near Ke=0 eV under suboptimal RF phase point.

One or more performance metrics, such as those discussed above, can be employed to tune the phases and/or amplitudes of RF A and RF B signals to achieve optimal values of the phases and/or amplitudes. Typically, retuning of these parameters is required during an experiment, e.g., due to changes in the circuit capacitance that can lead to a change in the optimal values of the phases and/or amplitudes of the RF A and RF B signals for a desired performance characteristic of the mass spectrometer. Typically, the range of RF phases and/or amplitudes required for a well-tuned system can be narrow, thus necessitating frequent retuning of the system.

As noted above, in embodiments, the present teachings allow controlling (e.g., digitally) the phases and/or amplitudes of the RF A and RF B signals, e.g., based on monitoring one or more performance characteristics, so as to ensure that these parameters remain within a range needed for an optimal operation of the mass spectrometer.

In view of the foregoing, according to embodiments of the present teachings, a circuit is implemented to provide independent digital control for RF A and RF B phases and amplitudes. In some such embodiments, the circuit can include two RF generators for generating the RF A and RF B signals, where the signals are applied to the two pole electrode sets via two circuit paths, where each circuit path includes an inductive element (a tank coil) that is independent of a respective inductive element provided in the other circuit path.

A phase detector can measure at least one phase associated with the RF A or RF B signal and a controller having a feedback loop can apply control signals to at least one of the RF generators, based on the measured phase, to maintain the phase differential between the RF A and RF B signals within a target range. In some embodiments, the phase of one of the RF A or RF B signals can be fixed and the phase of the other signal can be controlled to maintain the phase differential between the RF A and RF B signals within a desired target range during operation.

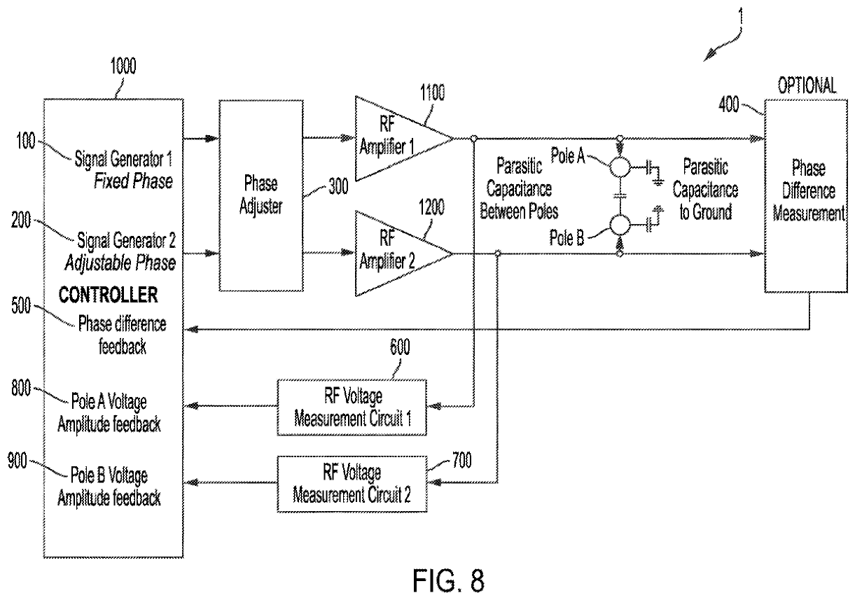

FIG. 8 schematically depicts a system 1 according to an embodiment of the present teachings for application of RF voltages to the poles 17 and 18 of a multipole ion processing device employed in a mass spectrometer. Some examples of such ion processing devices can include, without limitation, any of an ion guide, an ion device with multiple poles, an ion trap, an ion reaction device, and an ion mass filter.

Referring to FIG. 8, the system 1 can include a first RF generator 100 configured to generate an RF A voltage (herein also referred to as a first RF voltage) for application to one (e.g., Pole A) of the two pole electrode sets of the ion processing device and a second RF generator 200 configured to generate an RF B voltage (herein also referred to as a second RF voltage) for application to the other (e.g., Pole B) of the two pole electrode sets. By way of example, the Pole A can be formed by a pair of quadrupole electrodes, namely, a pair of 17a and 17c or a pair of 17a and 18a. The Pole B can be formed by a pair of 17b and 17d or a pair of 17b and 18b.

In this embodiment, the first RF voltage has a fixed phase output, and the second RF voltage has a variable phase output, which can be controlled via a feedback circuit to ensure that the phase differential between the RF A and RF B voltages remains within a desired target range or at a target value. In other embodiments, the phases of both the RF A and RF B voltages can be variable, and the circuitry can be designed to maintain the phase differential within a target range or at a target value.

More specifically, a phase adjustor 300 is provided in communication with the first RF generator 100 and the second RF generator 200 to adjust the variable phase output of the second RF generator 200 so as to maintain a phase differential between the first and second RF voltages at or in proximity of a predetermined value or within a desired range. By way of example, the predetermined value for the phase differential can be −180 degrees. However, the present teachings are not limited thereto, and the target phase differential value can be set by a user for optimal performance of the ion processing device. In some embodiments, the target phase differential value can be determined in-situ by monitoring one or more performance metrics.

In this embodiment, the system 1 can include a phase discriminator 400, which determines the phase differential between the first and the second RF voltages and generates a signal indicative of the phase differential, and a feedback circuitry 500, which receives the signal indicative of the phase differential from the phase discriminator 400 and adjusts the phase of the second RF voltage so as to maintain the phase differential at a predetermined value or within a predetermined range.

Further, whereas the phase outputs of the first and the second RF voltages are adjusted relative to each other, the amplitudes of the RF voltages can be adjusted independently. Accordingly, in this embodiment, the system 1, in addition to being configured to control the phase differential between the RF A and RF B voltages, can also be configured to adjust the amplitudes of the RF A and RF B voltages generated by the first RF generator 100 and the second RF generator 200, respectively. For controlling the amplitudes of the RF A and RF B voltages, the system 1 can include RF voltage detectors 600 and 700, each configured to generate a signal indicative of the amplitude of one of the RF A and RF B voltages, respectively, and feedback circuitries 800 and 900 for receiving the signal indicative of the amplitude and generating one or more feedback signals for controlling the amplitudes of the RF signals generated by the RF signal generators.

As shown in FIG. 8, the first RF generator 100, the second RF generator 200, the feedback circuitry 500 for phase control, the feedback circuitry 800 for controlling the amplitude of RF voltage generated by the first RF generator 100, and the feedback circuitry 900 for controlling the amplitude the RF voltage generated by the second RF generator 200 can be implemented within a control unit 1000. As discussed above, the control unit 1000 can be implemented as a digital circuitry using techniques known in the art as informed by the present teachings.

In some implementations, the control unit 1000 measures and controls the first and second RF voltages individually and independently. Based on the individual and independent control of the two RF voltages, the performance metrics can be optimized via feedback-control. In some embodiments, the control unit 1000 can monitor one or more performance metrics, such as those discussed above, and feedback-control the phase differential to maintain the optimal performance metrics. In some embodiments, the optimal phase differential can be predetermined and set by a user, and the control unit 1000 can monitor the phase differential to maintain it at the predetermined value or within a predetermined range. In some embodiments, operating parameters can be predetermined based on the optimal phase differential and set by a user, and the control unit 1000 can operate the RF generators with the predetermined operating parameters. In any embodiment, the primary object is to maintain the balance and phase of the RF voltages applied to the two pole electrode sets with respect to ground at an optimal value so as to obtain an optimal performance of the mass spectrometer

In some embodiments, one or more of the feedback circuitries 500, 800, and 900 for adjusting the phase and/or the amplitude can be implemented in a proportional-integral-derivative (PID) controller in a manner known in the art as informed by the present teachings.

In some implementations, the first RF voltage and the second RF voltage can have a sinusoidal temporal profile. In some other implementations, the first RF voltage and the second RF voltage can be non-sinusoidal. In general, the shape of the waveform associated with the RF voltages applied to the two pole electrode sets of an ion processing device are the same. In some implementations, the first and second RF voltages can have the same (fundamental) frequency. In some embodiments, the frequency of the RF voltage generated by any of the two RF generators can be, for example, in a range of about 100 kHz to about 10 MHz, and the amplitude of the RF voltage generated by any of the two RF generators can be, for example, in a range of about 50 V to about 5 kV.

In an aspect of the present teachings, instead of adjusting or controlling the amplitudes of the RF voltages by controlling the RF generators 100 and 200, the amplitudes can be adjusted by changing the capacitance of one or more balancing capacitors 1300a and 1300b and/or a tuning capacitor 1400 as shown in FIG. 9. In such embodiments, the tuning capacitor 1400 can be used to adjust the impedance of the circuit so as to establish resonance, and the balancing capacitors 1300a and 1300b can be used to match the amplitudes of the voltages applied to Poles A and B. In use, after adjusting the balancing capacitors 1300a and 1300b, the tuning capacitor 1400 can be re-adjusted for resonance, and the procedure can be iteratively repeated for fine-tuning of the resonance and balance.

In some embodiments, the balancing capacitors 1300a and 1300b and/or the tuning capacitor 1400 are adjusted via an electromechanical actuator 1500. For example, such electromechanical adjustment of the capacitance can be implemented with any devices known in the art such as, for example, a servo motor, a step motor, a linear motor, a hydraulic actuator, a pneumatic actuator, and the like. In some such embodiments, the electromechanical actuator 1500 can be manually operated. For the manual operation, any wired or wireless manner known in the art can be employed. In some other embodiments, the electromechanical actuator 1500 can be automatically operated based on a feedback circuitry 1600. FIG. 10 schematically shows an example of a variable capacitor that can be adjusted by an electromechanical actuator 1500 based on one or more signals supplied from the feedback circuitry 1600.

In some embodiments, there may be a mapping between input phase delay and one or more performance metrics such that the input phase delay can be controlled based on the mapped data by monitoring the performance metrics of the system. For example, the phase adjuster can adjust the input phase delay until an optimal performance metric is achieved. By way of example, such a performance metric can be any of the intensity of a mass peak in a mass spectrum, the electron current emitted by the filaments, or the electron capture efficiency. In some embodiments, the performance metrics of the system can be mapped with respect to input signals to the electromechanical actuator 1500 such that the feedback circuitry 1600 can control the electromechanical actuator 1500 based on the mapping by monitoring the performance metrics.

Referring back to FIG. 8, the RF signals generated by the first RF generator 100 and the second RF generator 200 can be amplified, respectively, via RF amplifiers 1100 and 1200 before their application to the pole electrode sets of the ion processing device associated with the RF generators. Each of the RF amplifiers 1100 and 1200 can be implemented as a high-efficiency gain circuit/block such as in the form of a resonant circuit including an inductor and/or a transformer.

In FIG. 8, the phase discriminator 400 is shown to be in communication with Pole A and Pole B of the ion processing device to measure a phase differential of the RF voltages applied to the two poles A and B. However, the present teachings are not limited to such a configuration, and the phase discriminator 400 can be connected elsewhere, e.g., at immediate downstream of the phase adjustor 300 or downstream of the RF amplifiers 1100 and 1200.

### Example

The performance of a prototype circuit based on the design shown in FIG. 8 has been further characterized in a branched RF ion trap, such as that discussed above in connection with FIGS. 1A-1D, having two filaments 1 and 2 for generating electrons, where each filament is positioned relative to the entrance of one of the branches for introduction of the generated electrons into that branch.

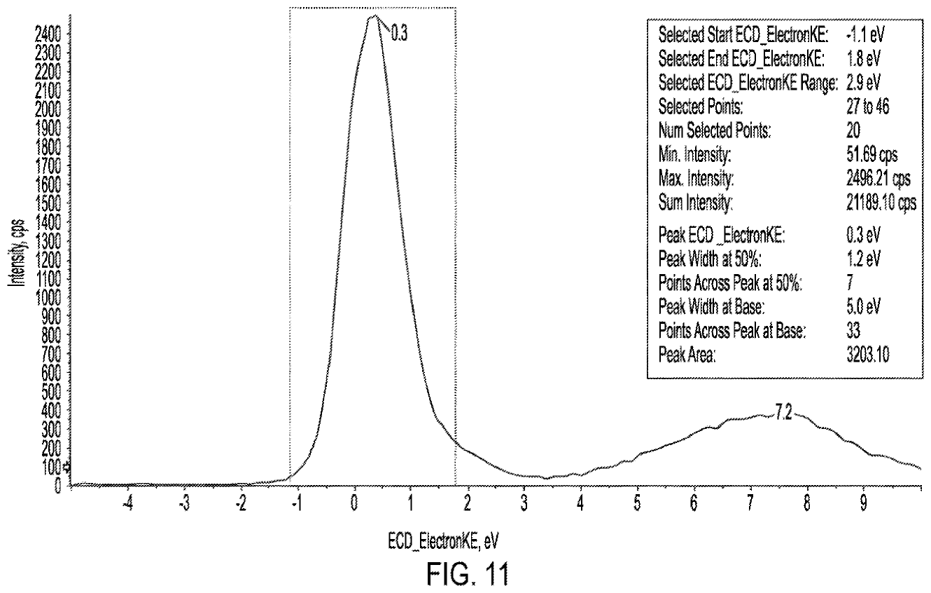

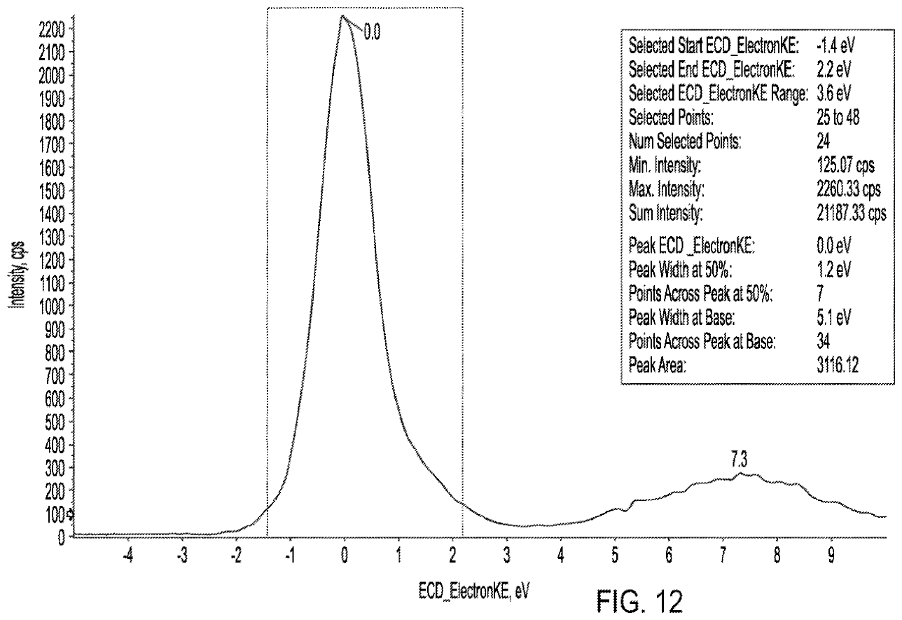

The electron capture reaction of Triacetyl-β-cyclodextrin was monitored using both filament 1 and filament 2. After appropriate tuning, for both RF balance and RF phase, it was observed that the performance of the circuit exhibited a significant improvement for the operation of two filaments with independent optimal settings. In particular, it was possible to achieve electron capture efficiency plot dependent on electron kinetic energies. FIGS. 11 and 12 show performance for optimal operations, where a sharp resonance capture was observed with Ke near 0 eV. More specifically, FIGS. 11 and 12 show electron capture efficiencies for 2⁺ ammoniated Triacetyl-β-cyclodextrin ion using filament 1 and filament 2, respectively. FIGS. 11 and 12 demonstrate a narrow peak (FWHM=1.2 eV) around 0 eV kinetic energy, which indicates best expected theoretical performance.

Although some aspects have been described in the context of a system and/or an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware and/or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Those having ordinary skill will appreciate that various changes can be made to the above embodiments without departing from the scope of the invention.

What is claimed is:

1. A system for applying RF voltages to an ion processing device having at least two pole electrode sets, configured for use in a mass spectrometer, the system comprising:
a first RF generator configured to generate a first RF voltage and apply to a first pole electrode set;
a second RF generator configured to generate a second RF voltage and apply to a second pole electrode set;
a first amplitude adjustor configured to adjust an amplitude of said first RF voltage;
a second amplitude adjustor configure to adjust an amplitude of said second RF voltage; and
a phase adjustor in communication with said first RF generator and said second RF generator to adjust phase output of at least one of said first RF generator and said second RF generator so as to adjust a phase differential between said first RF voltage and said second RF voltage to be within a desired range.

2. The system of claim 1, wherein said first RF voltage has a fixed phase output, and said second RF voltage has a variable phase output, and
wherein said variable phase output of said second RF voltage is configured to be adjusted by said phase adjustor.

3. The system of claim 1, wherein said ion processing device comprises any of an ion guide, an ion device with multiple poles, an ion trap, an ion-ion reaction device, ion-electron reaction device, ion-neutral reaction device, and an ion mass filter.

4. The system of claim 1, further comprising:
a phase discriminator for determining the phase differential between said first RF voltage and said second RF voltage and generating a signal indicative of said phase differential; and
a feedback circuitry for receiving said signal and adjusting the phase of said second RF voltage so as to maintain said phase differential to a predetermined value.

5. The system of claim 4, wherein the predetermined value is about −180 degrees.

6. The system of claim 4, wherein said feedback circuitry is implemented in a proportional-integral-derivative (PID) controller.

7. The system of claim 1, wherein each of said first amplitude adjustor and said second amplitude adjustor comprises:
a detector configured to generate a signal indicative of an amplitude of respective RF voltages; and
a feedback circuitry for receiving said signal and generating a feedback signal for application to respective RF generators.

8. The system of claim 7, wherein said feedback circuitry is configured to balance said amplitude of respective RF voltages so as to optimize one or more performance metrics of said ion processing device.

9. The system of claim 1, further comprising at least one RF amplifier positioned between at least one of said RF generators and pole electrode sets of the ion processing device associated with said at least one RF generator.

10. The system of claim 9, wherein said at least one RF amplifier comprises a resonant tank coil.

11. The system of claim 1, further comprising an additional RF amplifier between an input signal and output signal, said additional RF amplifier comprising a resonant tank coil.

12. The system of claim 1, wherein said first RF generator, said second RF generator, or both are implemented as a digital circuitry.

13. The system of claim 4, wherein said phase discriminator is in communication with said first pole electrode set and said second pole electrode set, thereby measuring the phase differential therebetween.

14. The system of claim 1, wherein said system drives an RF ion trap configured to simultaneously trap ions and introduce electrons for ion-electron reaction.

15. The system of claim 14, wherein relative balance of amplitudes of said first and second RF voltages is adjusted to minimize the RF field-induced distortion along the axis of electron introduction.

16. The system of claim 14, wherein said phase differential between said first and second RF voltages is adjusted to minimize the RF field-induced distortion along the axis of electron introduction.

17. The system of claim 14, wherein said RF ion trap is capable of introducing ions and collecting products, and at least one port is provided for introducing electrons.

18. The system of claim 14, wherein said RF ion trap is implemented in a branched configuration.

19. The system of claim 18, said RF ion trap with the branched configuration comprises:
a plurality of L-shaped rods arranged relative to one another to provide an axial passageway having an inlet for receiving a plurality of ions and an outlet through which ions are allowed to leave the axial passageway, and a transverse passageway having at least one inlet for receiving electrons generated by an electron source,
wherein said plurality of L-shaped rods form an ion guide providing a passageway for transmission of ions therethrough,
wherein said axial and transverse passageways intersect at an electron-ion interaction region in which at least a portion of the received electrons interact with at least a portion of the received ions, and
wherein said RF ion trap is configured to ensure that electrons remain substantially close to a central axis of said transverse passageway while propagating along said transverse passageway.

20. A method of operating an ion-electron reaction device having at least two pole electrode sets, the method comprising:
applying a first RF voltage to a first pole electrode set of the ion-electron reaction device;
applying a second RF voltage to a second pole electrode set of the ion-electron reaction device;
adjusting an amplitude of said first RF voltage and an amplitude of said second RF voltage; and
adjusting a phase output of at least one of said first RF generator and said second RF generator so as to adjust a phase differential between said first RF voltage and said second RF voltage to be within a desired range.

21-23. (canceled)
